(19) United States
(12) Patent Application Publication
(10) Pub. No.: US 2025/0278077 A1
(43) Pub. Date: Sep. 4, 2025

(54) System and Method for Post-Production Part Lot Grading

(71) Applicant: Cox Manufacturing Company, Inc., San Antonio, TX (US)

(72) Inventors: William T. Cox, JR., San Antonio, TX (US); Can Saygin, Helotes, TX (US)

(73) Assignee: Cox Manufacturing Company, Inc., San Antonio, TX (US)

(21) Appl. No.: 18/591,048

(22) Filed: Feb. 29, 2024

(51) Int. Cl. G05B 19/418; G06Q 10/0639; G06Q 50/04

(52) U.S. Cl. CPC G05B 19/41875; G06Q 10/06395; G06Q 50/04; G05B 2219/32368

(57) ABSTRACT

A method, system and computer-usable medium are disclosed for determining acceptance or rejection of part lots after production. A part lot of parts is processed/machined. Parts are sampled in particular size and frequency during production. Critical to lot quality (CTQ) events that occur during sampling of parts are determined and monitored. Weighted values are assigned if CTQ events occurred for all the sampled parts. A production lot score is calculated based on the weighted values of the CTQ events. Acceptance or rejection of the part lot is based on the calculated lot score.

### BACKGROUND OF THE INVENTION

### Field of the Invention

The present application relates generally to an improved system and method post-production part lot grading. More specifically, embodiments of the invention provide for determining acceptance or rejection of part lots to reduce cost of quality.

### Description of the Related Art

In automated machining of parts, lots of parts (part lots) are produced. Certain assurance is needed as to quality control of the machined parts. In specific, determining if a part lot is acceptable or not acceptable. Inspection of part lots can involve significant resources, including manual inspection of parts. This cost of quality increases with higher frequency and volume of part lots to be inspected to assure part quality. The greater the number of part lot inspection, the greater the cost of quality.

Considering that a part lot can include a great number of parts (e.g., a thousand parts in a part lot), it is not practical to inspect all of the parts, and identify and remove defective parts in the part lot. For such high volume production environments, sampling plans are typically used to determine whether to accept or reject a part lot based on a number of parts to be randomly sampled out of the part lot, which is called the sample size, and the associated acceptance criteria, which provides a decision to accept or reject the part lot based on number of defective parts identified in the sample. If the sample meets the acceptance criteria, then the whole part lot is accepted as “meeting specifications” without having to inspect all of the parts of the part lot.

Sampling plans can statistically recommend certain sample size of parts to be sampled or observed. The sample parts are inspected and evaluated to further decide if the part lot is to be accepted or rejected. There can be sample plans of different levels of risk which can depend on lot quality level requirement factor(s) (i.e, cost of quality), which can include the quantity of parts to inspect before passing on as a part lot.

Certain known practices and technology address various attributes during parts production to improve process quality to avoid making defective parts, or to identify and isolate potentially defective parts due to undesirable process capability at the time of production. Such practices and technology do not address post-production of part lots.

### SUMMARY OF THE INVENTION

A method, system and computer-usable medium are disclosed for determining acceptance or rejection of a part lot, post-production comprising processing or machining the part lot; sampling parts of the part lot during processing/machining; determining critical to lot quality (CTQ) events that occur during sampling of parts, wherein weighted values are assigned if CTQ events occurred for all sampled parts; calculating a part lot score based on the weighted values of the CTQ events; and determining acceptance or rejection of a part lot based on its calculated part lot grade.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of an information processing system for implementing the processes of the described invention;

FIG. 2 is a block diagram of a system for implementing the processes of the described invention;

FIG. 3 illustrates a critical to lot quality (CTQ) events table;

FIG. 4 is a generalized flowchart for machining of parts, part sample inspection during production, and grading of part lots, post-production;

FIG. 5 illustrates a part lot acceptance/rejection table based on part lot grades; and

FIG. 6 is a generalized flowchart for determining acceptance or rejection of a part lot.

### DETAILED DESCRIPTION

Described herein are a method, system, and computer-readable storage medium for product lot quality assurance. Process data that is collected during production of a part lot is utilized. The process data includes statistical process control data based on a parts sampling plan that includes number of parts to be sampled and frequency of sampling, and production events that occurred during machining of parts. The process data associated with a part lot is then used to grade the part lot. The part lot grade then is used to determine acceptance or rejection of the part lot. When acceptance or rejection (i.e., evaluation) of a part lot is done in a more efficient way, inspection cost of part lots is reduced, where good (acceptable) part lots are not inspected, and only suspected bad (rejected) part lots are inspected. This leads to a reduction in cost of quality.

Implementations provide for post-production grading of a part lot based on production events and attributes captured in real-time during manufacturing/processing of parts of the part lot. Production events in the manufacturing/processing of the parts can be identified as critical and are used in lot acceptance/rejection decision. The lot grading method relies on presence of critical to lot quality production events as risk factors for making lot acceptance/rejection decisions.

The production events during machining of parts can affect part quality. For example, when in-process control allows for process data collection based on sampling of parts, shifting trends in part dimensions captured from part samples can be used to correlate to part quality. Such real-time production data can be associated with part lots to make post-production decisions whether to accept/reject a part lot, where production data show no process issues or show process issues, and designating a part lot acceptance plan based on the criticality of the process issues that are captured during production of the part lot.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

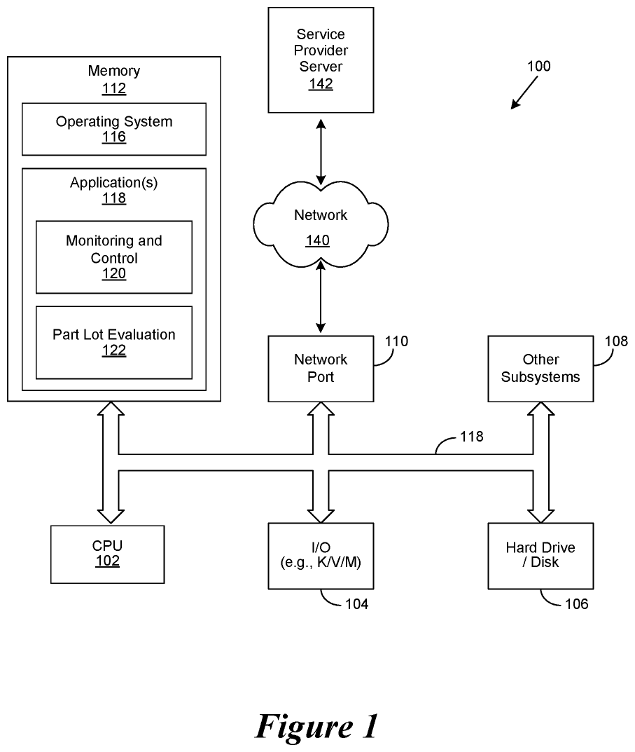

FIG. 1 a generalized illustration of an information handling system that can be used to implement the system and method of the present invention. The information handling system includes a central processor unit (CPU) 102, input/output (I/O) devices 104, such as a microphone, a keyboard, a video/display, a mouse, and associated controllers, a hard drive or disk storage 106, and various other subsystems 108. As further described herein, other subsystems 108 can include other subsystems, such as material (e.g., metal bar) loaders, lathing machines, drilling machines, cutting machines, etc.

In various embodiments, the information handling system in FIG. 1 also includes network port 110 operable to connect to a network 140, which is likewise accessible by a service provider server 142. The information handling system likewise includes system memory 112, which is interconnected to the foregoing via one or more buses 114. System memory 112 further comprises operating system (OS) 116. System memory 112 includes applications 118. As further described herein, applications 118 can include monitoring and control 120 and part lot evaluation 122. As further described herein, monitoring and control 120 provides for monitoring and controlling machining of parts, and configured to analyze the behavior of a machining system, and particularly the processing of parts by the machining parts, where the parts have certain dimensions. As further described herein, part lot evaluation 122 provides for post-production grading of a part lot based on production events and attributes captured in real-time during the production of the part lot.

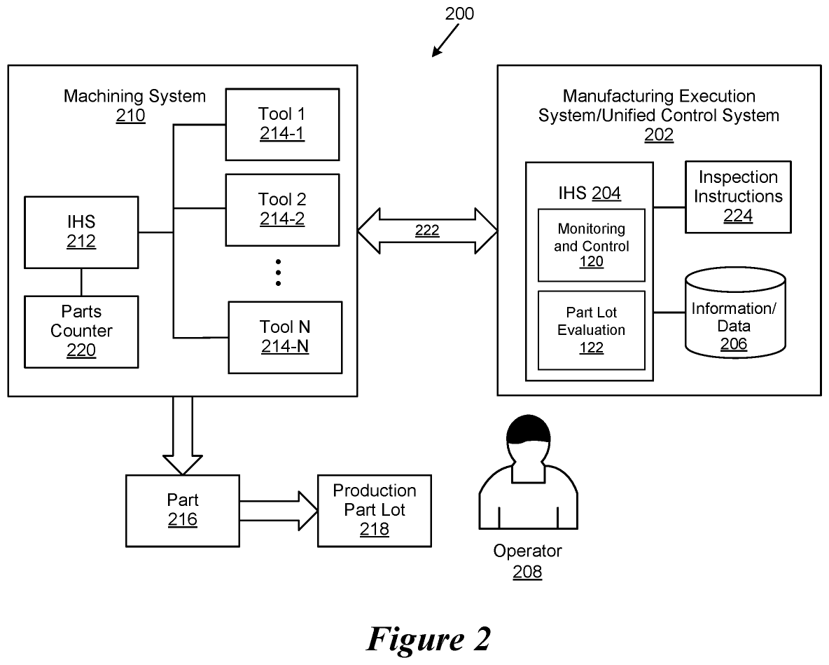

FIG. 2 shows a system implementing the processes of the described invention. In particular, the system 200 supports a high-volume production process of parts and determining acceptance or rejection of part lots to reduce cost of quality. In certain embodiments, the system 200 includes a manufacturing execution system/unified control system 202. In certain embodiments, the unified control system 202 includes an information handling system (IHS) 204, such as IHS 100 as described in FIG. 1. IHS 204 can include monitoring and control 120 and part lot evaluation 122.

Implementations can provide for a database or data/information store 206 to be included with or connected to the manufacturing execution system/unified control system 202. As further described below, certain data/information used in the monitoring and controlling of machining process of parts can be stored in the data/information store 206. A technician or operator 208 (e.g., operating technicians, process engineers, etc.) interacts with system 200, and can view data/information as to the monitoring and controlling of the machining process and determining acceptance or rejection of part lots. As described in FIG. 1, the various IHS of system 200 include input/output (I/O) devices 104 to allow operation 208 to interact with the system 200.

The system 200 further includes a machining system 210. The machining system 210 can include an IHS 212, such as IHS 100 as described in FIG. 1. In certain implementations, the machining system 210 is used to machine parts and can include other subsystems, such as material (e.g., metal bar) loaders, turning machines (lathes), drilling machines, milling machines, etc. In other implementations, the machining system 210 is used to produce other parts. It is to be understood that machining system 210 may be used for other production processes and can include different subsystems.

The machining system 210 includes tool 1 214-1 to tool N 214-N, and processes raw material to create part(s) 216 which are part of part lot 218. Embodiments further provide for the machining system 210 to include a parts counter 220 which counts parts 216 as they are processed by machining system 210. In real time, dimensional data of machined sampled parts 216 are gathered at a certain frequency during a production process. The parts can be produced based on part control plan, which includes specifications of dimensions, sampling size and frequency, and related inspection requirements. The dimensional data of the part samples are plotted as a normal distribution curve following statistical process control principles. Based on the statistics of the curve, corrective action can be taken if a trend is visible in terms of the dimensional data approaching an upper control limit or a lower control limit or an increase in process variation.

In certain implementations, the machining system 210 is connected to the manufacturing execution system/unified control system 202 by a two-way connection 222, such as network 140 described in FIG. 1. The manufacturing execution system/unified control system 202 can be enabled to receive process control data/information from the machining system 210, such as inspection data of part samples and production events that are critical to lot quality (CTQ) events as described herein.

Due to high-volume production nature of the machining process, it may not be feasible to perform 100% inspection. Instead, the system 200 takes samples of parts 216 at a certain frequency, following inspection instructions 224 specified in a control plan. In certain implementations, inspection instructions 224 can be user/operator 208 defined. Implementations provide for inspection data to be collected in

information/data captured database 206. Operational conditions on the machining system 210 can be maintained. When needed, tool changes and resetting of machine parameters can be performed. Such production events, that are critical to lot quality (CTQ), can be timestamped and stored in information/data captured database 206. When a part lot 218 is completed, the information/data captured database 206 includes inspection data of sample parts taken during the production of the lot, as well as production events such as tool off-sets, tool changes, etc.

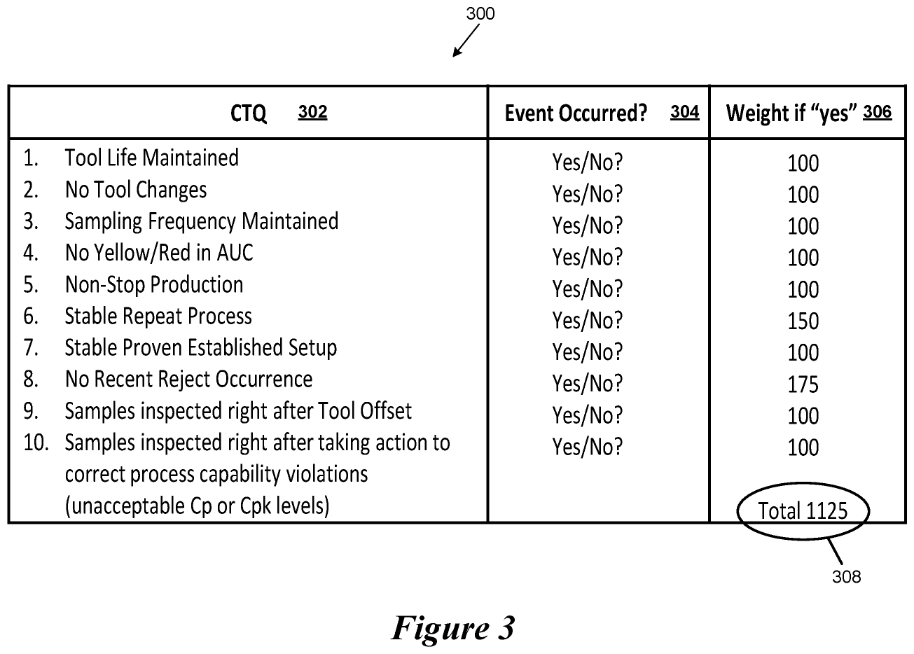

FIG. 3 shows a critical to lot quality (CTQ) events table. The table 300 lists example critical to lot quality (CTQ) events 302 that are process control data/information such as inspection data of part samples and production events. The CTQ events 302 are used as further described herein in determining acceptance or rejection of certain part lots 218.

Examples of CTQ events 302 include “Tool Life Maintained”, “No Tool Changes”, “Sampling Frequency Maintained”, “No Yellow/Red in AUC (advanced unified control, i.e., manufacturing execution system/unified control system 202)”, “Non-Stop Production”, “Stable Repeat Process”, “Stable Proven Established Setup”, “No Recent Reject Occurrence”, “Samples Inspected Right After Tool Offset”, and “Samples Inspected Right After Taking Action To Correct Process Capability Violations (i.e., unacceptable Cp or Cpk levels, where Cp is defined as a ratio of upper specification limit (USL) minus lower specification limit (LSL) over six times the process standard deviation, and Cpk is the smallest of the distance from the process mean to USL or LSL (whichever one is smaller).

Table 300 includes an “Event Occurred” column 304, which indicates whether a CTQ event 302 occurs during production of a part lot 218. The “Event Occurred” column 304 is either a Yes or a No, and a CTQ event 302 can take place or not take place during production or machining of any part 216 of the part lot 218. Weights are assigned to CTQ events 302, as represented in column 306. Certain CTQ events 302 can be considered as more critical than other CTQ events 302. If for any part 216 that is sampled during manufacturing, a CTQ event 302 does not take place, a No value is assigned to the CTQ event 302, no weight is given to the CTQ event 302 for the part lot 218. A total score is shown in total 308 for the part lot 218. As an example, if all sampled parts 216 passed CTQ events 302, and did not score a “No” under Event Occurred” column 304, then the part lot 218 receives 1125, as part lot score 308.

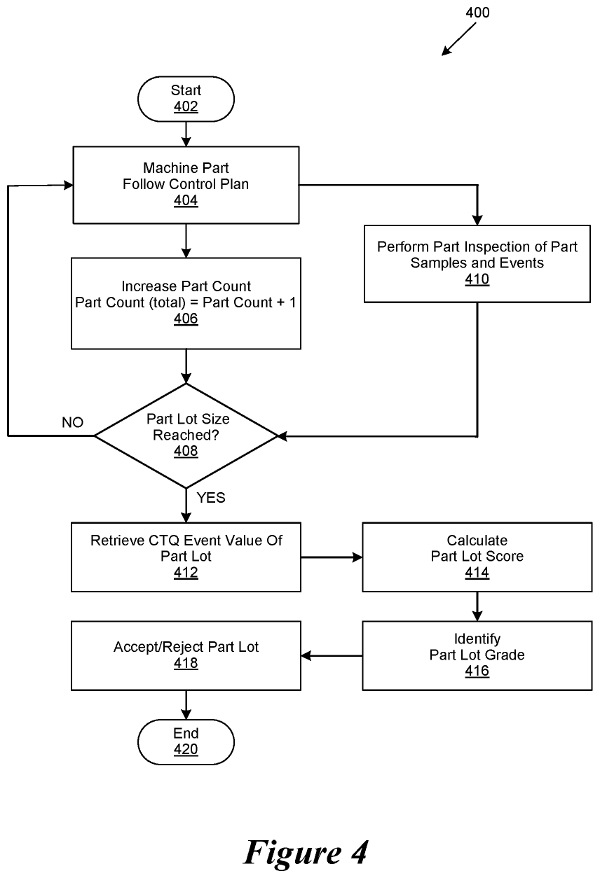

FIG. 4 is a generalized flowchart for part lot grading. The process 400 starts at production or machining of parts 216, collection data as to key production or CTQ events, and determining a part lot 218 score (e.g., total 308), to determine whether to reject or accept a part lot 218. Implementations provide for the system 200 to perform the process 400. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 402, the process 400 starts. At step 404, machining/processing of parts is performed. During the machining/processing, particular parts 216 of the part lot 218 are sampled. Implementations provide to follow a part control plan developed prior to parts production. The part control plan can be defined by personnel, which can include process engineers and can be based on the part print and customer requirements. As included in manufacturing execution system/unified control system 202, the part control plan can be a quality control and inspection file that provides, for example, dimensions on a part 216 to be inspected as to particular tool 214.

Sampling plans determine particular frequency of sampling of parts 216 and sample size. Sampling plans relate to different levels of risk, and quality level of inspection of production part lots 218. The more parts that are sampled, the less level of risk of making a wrong decision about the quality of a part lot, but greater cost of quality due to longer inspection time. Data gathered as to activities during machining/processing of parts 216 can provide information as to whether sampling size or sampling frequency should be changed.

At step 406, as parts 216 are completed, a Part Count (total) value is increased by “1”, Part Count (total)=Part Count+1. Implementations provide for parts counter 220 to perform this step. At step 408, a determination is performed whether the part lot 218 size is reached. If the part lot 218 size is not reached, following the NO branch of step 408, the process 400 returns to step 404.

In parallel, at step 410, inspection is performed of part 216 samples and production events (i.e., CTQ events 302) are captured. As an example, based on the size of a part lot 218, it may take two hours to produce 1000 parts 218. If frequency of sampling is every 30 minutes, there will be four samples of parts 216 that are inspected. Referring to FIG. 3, each part 216 is inspected based on the CTQ events 302. Each sampled part 216 is determined as to passing or not passing event occurred 304. If during any of the sampling, the event occurred 304 is a “No”, then weight 306 for the part lot is designated as zero for that particular CTQ event 302. Step 410 continues, until the part lot size 218 is reached.

Referring back to FIG. 4, after part lot 218 size is reached, following the YES branch of step 408, at step 412, referring to FIG. 3, the weighted values of column 306 for CTQ events 302 are retrieved. At step 414, the weighted values of column 306 for CTQ events 302 are summed up and totaled to determine a score or total value represented by total 308 of table 300.

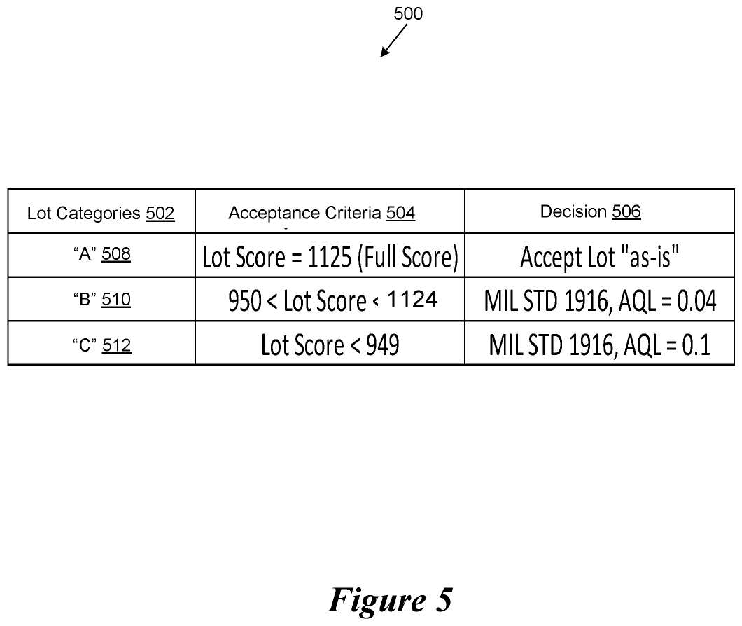

Referring back to FIG. 4, at step 416, a part lot size 218 score is identified/calculated. The part lot size 218 score is total 308 of table 300. Referring now to FIG. 5, a part lot grade table 500 is shown. The part lot grade table 500 includes a column Lot Categories 502, which identifies part lots, a column Acceptance Criteria 504 based on a range of part lot size 218 scores, and a column Decision 506 indicating whether to accept (pass) or reject a part lot size 218.

As an example, a part lot categorized as “A” 508 has a lot score of 1125 which is a full score and passes without further inspection or accepted “as is”. A part lot categorized as “B” 510 has a lot score between 950 and 1124, and may pass or not pass based on a criteria, such as MIL-STD-1916 with an acceptance quality level (AQL) of 0.04. A part lot categorized as “C” 512 has a lot score under 949, and may pass or not pass based on a criteria, such as MIL-STD-1916 with an acceptance quality level (AQL) of 0.1.

Referring back to FIG. 4, at step 418, based on the part lot size 218 score and table 500, a part lot is either accepted or rejected. At step 420, the process 400 ends.

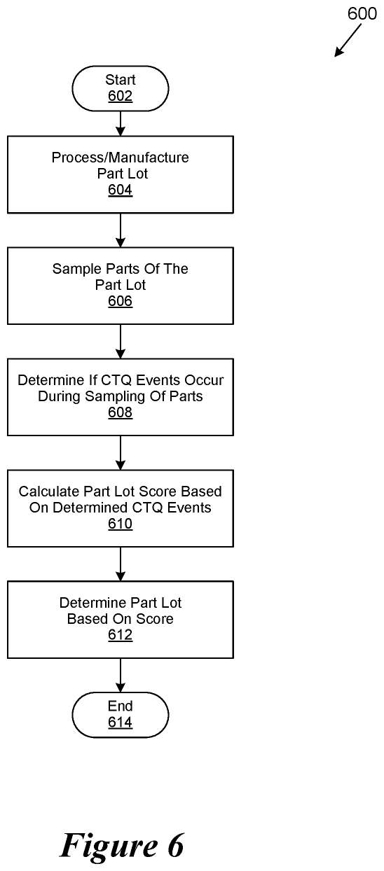

FIG. 6 is a generalized flowchart 600 for determining acceptance or rejection of part lot. Implementations provide for the system 200 to perform the process 600. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 602, the process 600 starts. At step 604, processing/manufacturing of a part lot is performed. Processing/manufacturing takes place until the part lot is completed.

At step 606, during the processing/manufacturing of the part lot, samples of parts are taken from the part lot for inspection. A sampling plan of a control plan can be used to determine sampling size and sampling frequency.

At step 608, production events or critical to lot quality (CTQ) events during the sample of parts are determined. Weighted values are given if the CTQ events occur, and no instance of the CTQ events not occurring took place during sampling of the parts.

At step 610, a part lot score is calculated based on the determined CTQ events. At step 612, acceptance or rejection of the part lot is determined based on the part lot score. At step 614, the process 600 ends.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method for determining acceptance or rejection of a part lot, post-production comprising:
processing or machining the part lot;
sampling parts of the part lot during processing/machining;
determining critical to lot quality (CTQ) events that occur during sampling of parts, wherein weighted values are assigned if CTQ events occurred for all sampled parts;
calculating a part lot score based on the weighted values of the CTQ events; and
determining acceptance or rejection of a part lot based on its calculated part lot grade.

2. The method of claim 1, wherein the weighted values represent risk factors.

3. The method of claim 1, wherein the part lot score is a sum of the weighted values of the CTQ events and is associated with a part lot grade.

4. The method of claim 1, wherein the processing is based on a control plan that includes a sampling plan that is used for the sampling of parts.

5. The method of claim 4, wherein the sampling plan is based on industry standards.

6. The method of claim 1, wherein CTQ events are captured in real time and time stamped.

7. The method of claim 1, wherein the determining acceptance or rejection of a part lot based on its calculated part lot grade is a sum of weighted score.

8. A system comprising:
a processor;
a data bus coupled to the processor; and
a computer-usable medium embodying computer program code, the computer-usable medium being coupled to the data bus, the computer program code for determining acceptance or rejection of a part lot, post-production comprising and comprising instructions executable by the processor and configured for:
processing or machining the part lot;
sampling parts of the part lot during processing/machining;
determining critical to lot quality (CTQ) events that occur during sampling of parts, wherein weighted values are assigned if CTQ events occurred for all sampled parts;
calculating a part lot score based on the weighted values of the CTQ events; and
determining acceptance or rejection of a part lot based on its calculated part lot grade.

9. The system of claim 8, wherein the weighted values represent risk factors.

10. The system of claim 8, wherein the part lot score is a sum of the weighted values of the CTQ events and is associated with a part lot grade.

11. The system of claim 8, wherein the processing is based on a control plan that includes a sampling plan that is used for the sampling of parts.

12. The system of claim 11, wherein the sampling plan is based on industry standards.

13. The system of claim 8, wherein CTQ events are captured in real time and time stamped.

14. The system of claim 8, wherein the determining acceptance or rejection of a part lot based on its calculated part lot grade is a sum of weighted score.

15. A non-transitory, computer-readable storage medium embodying computer program code for determining acceptance or rejection of part lot, the computer program code comprising computer executable instructions configured for:
processing or machining the part lot;
sampling parts of the part lot during processing/machining;
determining critical to lot quality (CTQ) events that occur during sampling of parts, wherein weighted values are assigned if CTQ events occurred for all sampled parts;
calculating a part lot score based on the weighted values of the CTQ events; and
determining acceptance or rejection of a part lot based on its calculated part lot grade.

16. The non-transitory, computer-readable storage medium of claim 15, wherein the weighted values represent risk factors.

17. The non-transitory, computer-readable storage medium of claim 15, wherein the part lot score is a sum of the weighted values of the CTQ events and is associated with a part lot grade.

18. The non-transitory, computer-readable storage medium of claim 15, wherein the processing is based on a control plan that includes a sampling plan that is used for the sampling of parts.

19. The non-transitory, computer-readable storage medium of claim 15, wherein CTQ events are captured in real time and time stamped.

20. The non-transitory, computer-readable storage medium of claim 15, wherein the determining acceptance or rejection of a part lot based on its calculated part lot grade is a sum of weighted score.
